(19) United States
(12) Patent Application Publication
(10) Pub. No.: US 2016/0010810 A1
(43) Pub. Date: Jan. 14, 2016

(54) ILLUMINATION DEVICE

(71) Applicant: PANASONIC INTELLECTUAL PROPERTY MANAGMENT CO., LTD, Osaka (JP)

(72) Inventors: Osamu TANAHASHI, Kyoto (JP); Yoshiyuki MIYAKE, Osaka (JP); Tadashi MURAKAMI, Osaka (JP); Hideharu KAWACHI, Hyogo (JP)

(21) Appl. No.: 14/771,705

(22) PCT Filed: Feb. 21, 2014
(86) PCT No.: PCT/JP2014/000913

§ 371 Date: Aug. 31, 2015

(30) Foreign Application Priority Data
Mar. 1, 2013 (JP) 2013-041156

(51) Int. Cl. F21K 99/00; F21V 3/02

(52) U.S. Cl. CPC F21K 9/50; F21V 3/02; F21Y 2105/008

(57) ABSTRACT

A light source unit which constitutes the present illumination device includes a planar light-emitting panel and a translucent material. The planar light-emitting panel has a light-emitting region from which light is emitted and a non-light-emitting region from which light is not emitted. The translucent material has a light incident surface which faces the light-emitting region and an inclined surface which faces the non-light-emitting region. The light incident surface is smaller than the light-emitting region. According to this configuration, even when a misalignment occurs between the planar light-emitting panel and the translucent material, the non-light-emitting region does not face the light incident surface, so that a front direction of the non-light-emitting region does not become dark section, and thus an appearance of the illumination device is improved. Moreover, the planar light-emitting panel and the translucent material do not need to be accurately arranged, so that higher yield is achieved.

### TECHNICAL FIELD

The present invention relates to an illumination device which has an organic electroluminescence (EL) element as a light source.

### BACKGROUND ART

The organic EL element emits light of high luminance at a low voltage, and various colors of the emitted light are obtained therefrom depending on types of organic compounds included in the organic EL element, and moreover, it is easy to manufacture the organic EL element as a planar light-emitting panel. As shown in FIG. 13, such a planar light-emitting panel 10 includes, for example, a base material 20, an organic EL element 30 provided in a center of the base material 20 and plural electrode pads 40 provided on the base material 20 so as to surround the organic EL element 30 (refer to Patent Document 1, for example). Each of the electrode pads 40 is electrically connected to an anode layer or a cathode layer (neither of them is shown) of the organic EL element 30 and mediates a power feeding to the anode layer or the cathode layer from an external power source. In the planar light-emitting panel 10, a region corresponding to the organic EL element 30 is a light-emitting region 10A from which light is emitted and a region where the electrode pads 40 are provided (shown by dots) surrounding the light-emitting region 10A is a non-light-emitting region 10B from which the light is not emitted.

As shown in FIG. 14A, as an illumination device using such a planar light-emitting panel 10 as a light source, there is an illumination device 50 which includes a translucent material 60 provided on a light-outputting surface side of the planar light-emitting panel 10 and a case 70 for storing the translucent material 60 and the planar light-emitting panel 10 (refer to Patent Document 2, for example). The translucent material 60 has a light incident surface 61 which faces the light-emitting region 10A of the planar light-emitting panel 10, a light outputting surface 62 which is located at a side opposite to the light incident surface 61, and an inclined surface 63 which faces the non-light-emitting region 10B of the planar light-emitting panel 10. The light incident surface 61 has a size identical to that of the light-emitting region 10A.

In the above illumination device 50, part of light (shown by a dashed line arrow) outputted from the planar light-emitting panel 10 and entering the translucent material 60 from the light incident surface 61 is reflected at the inclined surface 63 and outputted from the light outputting surface 62. In addition, another part of the light (shown by an alternate long and short dash line arrow) outputted from the planar light-emitting panel 10 directly enters the inclined surface 63, is refracted there, and is then outputted from the light outputting surface 62. Therefore, the light is outputted to a front direction of the non-light-emitting region 10B, so that the front direction of the non-light-emitting region 10B does not become dark section.

### PRIOR ART DOCUMENT(S)

### Patent Document(s)

Patent Document 1: Japanese Laid-Open Patent Publication No. 2012-182129

Patent Document 2: Japanese Laid-Open Patent Publication No. 2009-87830

### SUMMARY OF THE INVENTION

### Problems to be Solved by the Invention

In the above illumination device 50, the planar light-emitting panel 10 and the translucent material 60 are arranged with a predetermined gap against the case 70 in view of workability in assembling the illumination device 50. Accordingly, when the illumination device 50 is assembled, a misalignment of the planar light-emitting panel 10 relative to the translucent material 60 may occur. In a case such a misalignment occurs, as shown in FIG. 14B, if the light incident surface 61 and the light-emitting region 10A have the same size, a non-light-emitting region 10C, which is part of the non-light-emitting region 10B, is not covered by the inclined surface 63 and faces the light incident surface 61. In this case, a front direction of the non-light-emitting region 10C becomes extremely dark section, so that a black line appears in the light irradiation surface of the illumination device 50 and makes an appearance of the illumination device 50 awkward. The same applies to a misalignment of the translucent material 60 relative to the planar light-emitting panel 10. To prevent the appearance of such dark section, the planar light-emitting panel 10 and the translucent material 60 need to be accurately arranged without misalignment, so that a yield of the illumination device 50 may be lowered.

The present invention is to solve the above problems, and an object of the present invention is to provide an illumination device which gives higher yield and has an improved appearance regardless of whether a misalignment occurs or not between a planar light-emitting panel and a translucent material.

### Means to Solve the Problem(S)

One aspect of the present invention relates to an illumination device comprising a planar light-emitting panel having a light-emitting surface on one side; and a flat plate-shaped translucent material disposed on the light-emitting surface side of the planar light-emitting panel, wherein the planar light-emitting panel has a light-emitting region which emits light and a non-light-emitting region which is located around the light-emitting region and does not emit light, the translucent material has a light incident surface which faces the light-emitting region for entry of the light outputted from the light-emitting region, a light outputting surface which is located at a side opposite to the light incident surface and from which the light entering from the light incident surface is outputted, an inclined surface which connects a peripheral edge of the light outputting surface and a peripheral edge of the light incident surface and which obliquely extends outward from the peripheral edge of the light incident surface to face the non-light-emitting region, and a concave part provided on the light incident surface, and the light incident surface is smaller than the light-emitting region in size.

According to another aspect of the invention, the translucent material has a reflection part on the inclined surface to reflect light.

According to another aspect of the invention, the translucent material has a concave part on the light incident surface.

According to further aspect of the invention, the light outputting surface is prepared as a light diffusion surface which diffuses light.

According to further aspect of the invention, a light diffusion layer which diffuses light is further added onto the light outputting surface of the translucent material.

According to further aspect of the invention, the translucent material contains a light diffusion agent which diffuses light.

According to further aspect of the invention, the light incident surface and the planar light-emitting panel are adhered or stuck to each other via a translucent resin.

According to further aspect of the invention, the translucent material further has a peripheral frame which extends from a periphery of the light outputting surface so as to cover a side surface of the planar light-emitting panel.

### Effect of the Invention

According to the present invention, the light incident surface of the translucent material is smaller than the light-emitting region of the planar light-emitting panel, so that even when a misalignment occurs between the planar light-emitting panel and the translucent material, the non-light-emitting region of the planar light-emitting panel faces the inclined surface of the translucent material and does not face the light incident surface. Accordingly, a front direction of the non-light-emitting region does not become dark section, so that the illumination device has an improved appearance regardless of whether a misalignment occurs or not between the planar light-emitting panel and the translucent material. In addition, it is not necessary to accurately arrange the planar light-emitting panel relative to the translucent material, so that the illumination device gives higher yield.

### BRIEF DESCRIPTION OF THE DRAWINGS

FIG. 1 is an exploded perspective view of an illumination device according to a first preferred embodiment of the present invention;

FIG. 2A is a cross-sectional view of a light source unit which makes up the illumination device in FIG. 1;

FIG. 2B is an enlarged view of a region enclosed by a dashed line in FIG. 2A;

FIGS. 3A and 3B are cross-sectional views showing a misalignment of a planar light-emitting panel relative to a translucent material in the light source unit in FIG. 2A;

FIG. 4 is a cross-sectional view of a light source unit which makes up an illumination device according to a modification example of the first preferred embodiment;

FIG. 5 is a cross-sectional view of a light source unit which makes up an illumination device according to another modification example of the first preferred embodiment;

FIG. 6 is a cross-sectional view of a light source unit which makes up an illumination device according to still another modification example of the first preferred embodiment;

FIG. 7 is a cross-sectional view of a light source unit which makes up an illumination device according to still another modification example of the first preferred embodiment;

FIG. 8 is a cross-sectional view of a light source unit which makes up an illumination device according to still another modification example of the first preferred embodiment;

FIG. 9 is a cross-sectional view of a light source unit which makes up an illumination device according to still another modification example of the first preferred embodiment;

FIG. 10 is an exploded perspective view of a light source unit which makes up an illumination device according to a second preferred embodiment of the present invention;

FIG. 11 is a cross-sectional view of the light source unit in FIG. 10;

FIG. 12 is a cross-sectional view of a light source unit which makes up an illumination device according to a modification example of the second preferred embodiment;

FIG. 13 is s plane view of a general planar light-emitting panel; and

FIGS. 14A and 14B are cross-sectional views showing a misalignment of a planar light-emitting panel relative to a translucent material in a conventional illumination device utilizing the general planar light-emitting panel in FIG. 13 as a light source.

### DETAILED DESCRIPTION OF THE INVENTION

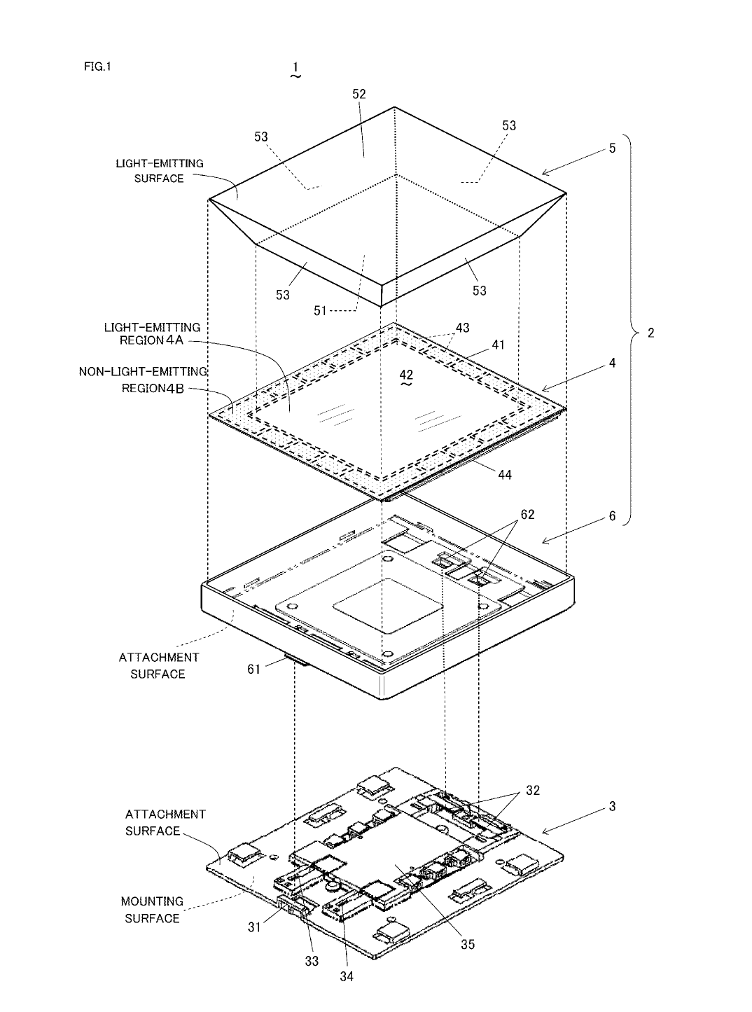

An illumination device according to a first preferred embodiment of the present invention is described with reference to FIGS. 1 to 3B. As shown in FIG. 1, an illumination device 1 includes a light source unit 2 and an attachment unit 3 to which the light source unit 2 is to be attached in a removable fashion.

The attachment unit 3 has a rectangular planar shape, and its one surface which faces the light source unit 2 is an attachment surface to which the light source unit 2 is to be attached, and another surface is a mounting surface which is to be mounted on a construction surface such as a ceiling and a wall. The attachment unit 3 has a holding part 31 and an engagement part 32 on the attachment surface. The holding part 31 and the engagement part 32 are utilized to engage the light source unit 2. In the illustration example, one holding part 31 is provided in a center of one side of the attachment surface and the two engagement parts 32 are provided in a center of the opposite side of the attachment surface. Moreover, the attachment unit 3 includes: one pair of terminal receiving parts 33, 34 into which one pair of power feeding terminals (not shown) provided in the light source unit 2 is inserted to supply power to the light source unit 2; and a circuit board 35 which is electrically connected to the terminal receiving parts 33, 34 and controls the power supply to the light source unit 2 from an external power source.

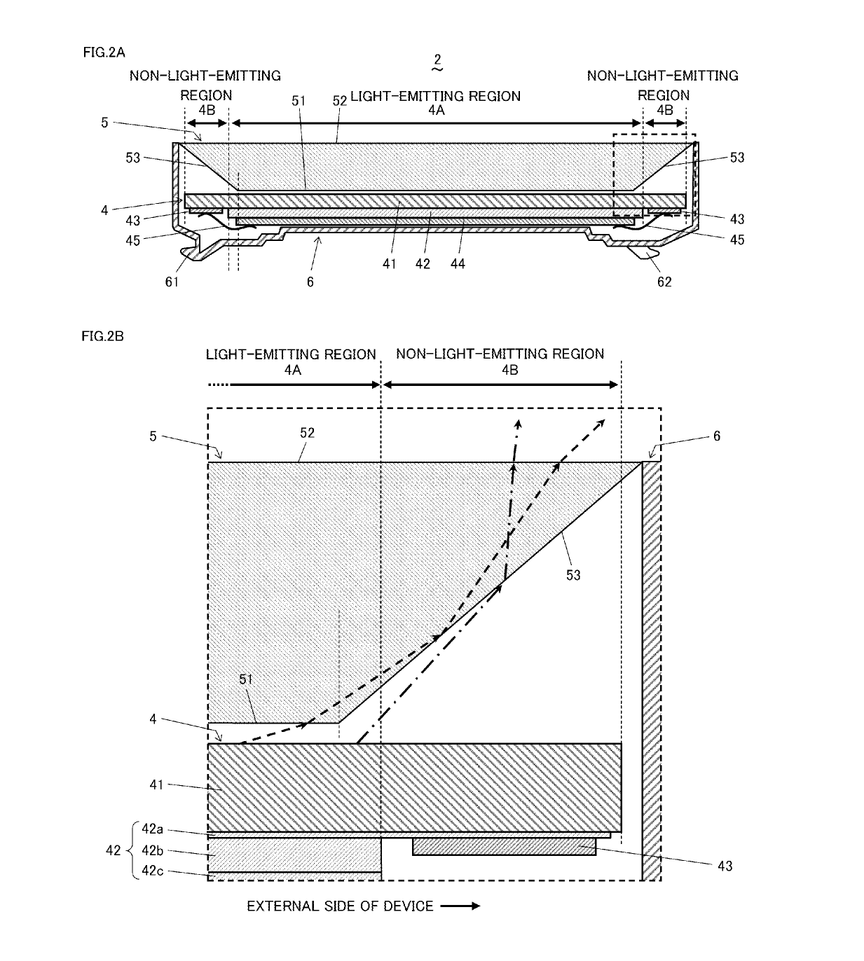

The light source unit 2 has a rectangular planar shape. One surface of the light source unit 2 which faces the attachment unit 3 is an attachment surface to which the attachment unit 3 is attached and another surface is a light-emitting surface. In the following description, according to FIG. 1, the light-emitting surface side is referred to as an upper surface side and the attachment surface side is referred to as a lower surface side. The light source unit 2 has a planar light-emitting panel 4 which has a light-emitting surface in an upper surface (one surface) and a translucent material 5 disposed on the upper surface side (the light-emitting surface side) of the planar light-emitting panel 4 (also refer to FIG. 2A). The planar light-emitting panel 4 and the translucent material 5 are held by a backside case 6 from the lower surface side of the planar light-emitting panel 4 so that the upper surface of the translucent material 5 is exposed to the outside.

The planar light-emitting panel 4 has a base material 41 having a rectangular planar shape, an organic EL element 42 having a rectangular planar shape and provided in a center of a lower surface of the base material 41, plural electrode pads 43 provided on the lower surface of the base material 41 so as to surround the organic EL element 42 and a wiring board 44 provided on the lower surface side of the organic EL element 42.

The base material 41 is made up of a translucent material such as a transparent glass plate. The organic EL element 42 has a general layer structure. In the illustration example (refer to FIG. 2B), the organic EL element 42 is configured by laminating, in order from the base material 41 side, an anode layer 42a, an organic layer 42b including an organic luminescent material and a cathode layer 42c having light reflectivity. Each of the anode layer 42a and the cathode layer 42c itself extends outside the organic layer 42b or is extended via an auxiliary electrode (not shown) and the electrode pads 43 are provided on the extended part of the anode layer 42a and the cathode layer 42c. Each of the electrode pads 43 is electrically connected to the wiring board 44 via conductive wire 45 (refer to FIG. 2A). The wiring board 44 has the pair of power feeding terminals (not shown) described above. Electrical power supplied from the circuit board 35 of the attachment unit 3 to the wiring board 44 via the power feeding terminal is supplied to the organic EL element 42 via the conductive wires 45 and the electrode pads 43. Since the electrode pads 43 are disposed around the organic EL element 42, the voltage applied to the organic EL element 42 becomes uniform, enabling the organic EL element 42 to emit the light with uniform luminance.

In the planar light emitting panel 4, a region where the organic EL element 42 is provided is a light-emitting region 4A from which the light is emitted. On the other hand, a region where the electrode pads 43 are provided (shown by dots in FIG. 1) is a non-light-emitting region 4B from which the light is not emitted.

The translucent material 5 has a rectangular planar shape and substantially the same size with the base material 41 of the planar light-emitting panel 4. The translucent material 5 is made up of a translucent material such as a transparent glass plate and a transparent acrylic resin plate. The translucent material 5 has a light incident surface 51 which faces the light-emitting region 4A of the planar light-emitting panel 4 for entry of the light outputted from the light-emitting region 4A, a light outputting surface 52 which is located at a side opposite to the light incident surface 51 and is larger than the light incident surface 51, and an inclined surface 53 which connects a peripheral edge of the light outputting surface 52 and a peripheral edge of the light incident surface 51.

The light incident surface 51 is smaller than the light-emitting region 4A of the planar light-emitting panel 4 in size (refer to FIGS. 2A and 2B). In the illustration example, the light incident surface 51 is exaggeratedly small for easy understanding but the light incident surface 51 only needs to be slightly smaller than the light-emitting region 4A. The inclined surface 53 obliquely extends outward from the peripheral edge of the light incident surface 51 and faces the non-light-emitting region 4B of the planar light-emitting panel 4. An angle between the inclined surface 53 and the surface of the planar light-emitting panel 4 is preferably 45°±10° so as to efficiently output the light to the front direction of the non-light-emitting region 4B (refer to the following description) and is appropriately determined in consideration of a size of the non-light-emitting region 4B or a thickness of the translucent material 5, for example.

The backside case 6 has a box shape with an opening on its upper surface and stores the planar light-emitting panel 4 and the translucent material 5. The backside case 6 has a supported part 61 engaged with the holding part 31 of the attachment unit 3 and an engaged part 62 engaged with the engagement part 32 of the attachment unit 3 on outside of its lower surface.

As shown in FIG. 2B, in the light source unit 2 configured as above, part of the light (shown by arrows of dash lines) outputted from the planar light-emitting panel 4 enters the translucent material 5 from the light incident surface 51 and is guided inside the translucent material 5. Afterwards, the light is totally reflected by the inclined surface 53 and then outputted to the front direction of the non-light-emitting region 4B. Another part of the light (shown by arrows of alternate long and short dash lines) outputted from the planar light-emitting panel 4 enters the translucent material 5 from the inclined surface 53 and is outputted to the front direction of the non-light-emitting region 4B. In this way, the light is outputted to the front direction of the non-light-emitting region 4B, so that the front direction of the non-light-emitting region 4B does not become dark section.

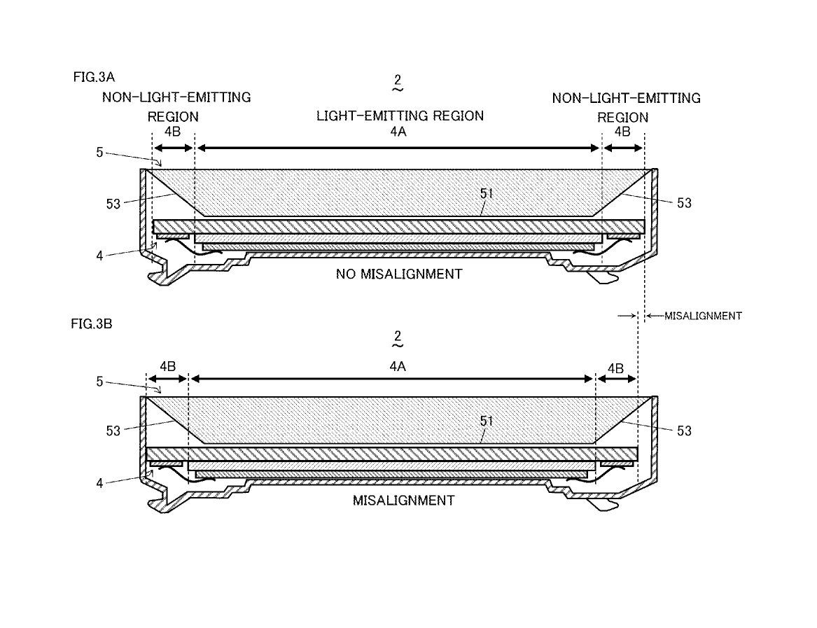

Next, a misalignment of the planar light-emitting panel 4 relative to the translucent material 5 in the light source unit 2 is described with reference to FIGS. 3A and 3B. FIG. 3A shows the light source unit 2 in which the planar light-emitting panel 4 is properly positioned relative to the translucent material 5. In contrast, FIG. 3B shows the light source unit 2 in which the planar light-emitting panel 4 is misaligned relative to the translucent material 5. As shown in FIG. 3B, even when the planar light-emitting panel 4 is misaligned relative to the translucent material 5, the light incident surface 51 of the translucent material 5 is smaller than the light-emitting region 4A of the planar light-emitting panel 4, so that the non-light-emitting region 4B of the planar light-emitting panel 4 faces the inclined surface 53 of the translucent material 5 but not the light incident surface 51. Although it is not described in detail, even when the translucent material 5 is misaligned relative to the planar light-emitting panel 4, the non-light-emitting region 4B does not face the light incident surface 51 in the same manner. Accordingly, even when the misalignment occurs between the planar light-emitting panel 4 and the translucent material 5, the front direction of the non-light-emitting region 4B does not become dark section.

As described above, according to the illumination device 1 of the present preferred embodiment, the front direction of the non-light-emitting region 4B does not become dark section regardless of whether the misalignment occurs or not between the planar light-emitting panel 4 and the translucent material 5, so that it is possible to obtain the light irradiation surface having uniform illuminance, and thus the appearance of the illumination device 1 is improved. Moreover, the illumination device 1 is configured to allow the misalignment between the planar light-emitting panel 4 and the translucent material 5, so that the planar light-emitting panel 4 and the translucent material 5 do not need to be accurately arranged in an assembly of the light source unit 2, and thus higher yield is achieved.

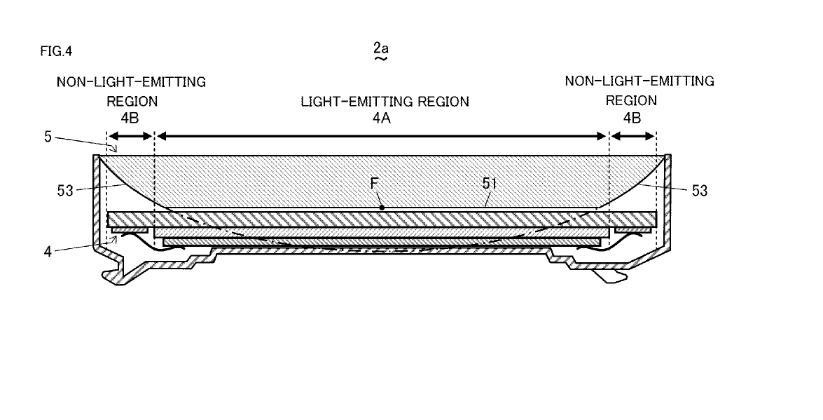

Next, a light source unit which makes up an illumination device according to a modification example of the above preferred embodiment of the present invention is described with reference to FIG. 4. In the light source unit 2a which is developed on the basis of the above light source unit 2, the inclined surface 53 of the translucent material 5 has a paraboloidal shape (shown by an alternate long and short dash line). The paraboloidal shape has a focus F on the light incident surface 51. According to such a configuration, the light which enters from the light incident surface 51 is reflected by the inclined surface 53 and outputted outside efficiently, so that it is possible to increase irradiation light luminance in the front direction of the non-light-emitting region 4B. Accordingly, irradiation light luminance difference between the non-light-emitting region 4B and the light-emitting region 4A is reduced. Moreover, the light incident surface 51 and the inclined surface 53 are smoothly connected, so that a refraction angle difference of the light between the light incident surface 51 and the inclined surface 53 is reduced, and a boundary between the light-emitting region 4A and the non-light-emitting region 4B becomes inconspicuous.

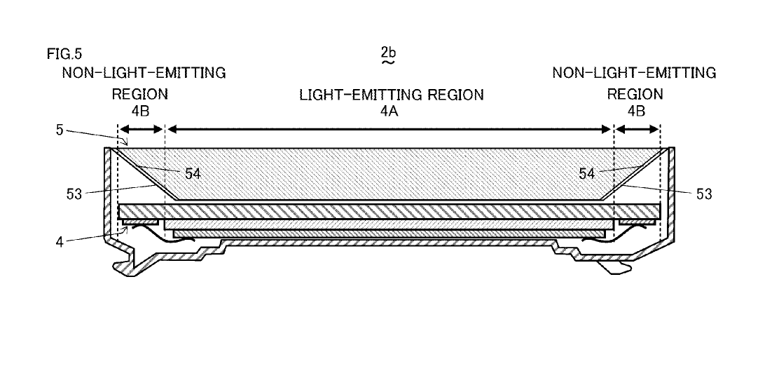

Next, a light source unit which makes up an illumination device according to another modification example of the above preferred embodiment is described with reference to FIG. 5. In a light source unit 2b which is developed on the basis of the above light source unit 2, a reflection part 54 is provided on the inclined surface 53 of the translucent material 5 to reflect light. The reflection part 54 is formed, for example, by applying a white coating material or sticking a white tape on the inclined surface 53 but not limited to these and is formed with any material which reflects and diffuses the light. By providing the reflection part 54 on the inclined surface 53, the light is efficiently reflected by the inclined surface 53 and effectively outputted outside, so that the irradiation light luminance in the front direction of the non-light-emitting region 4B increases, and thus the irradiation light luminance difference between the non-light-emitting region 4B and the light-emitting region 4A is reduced.

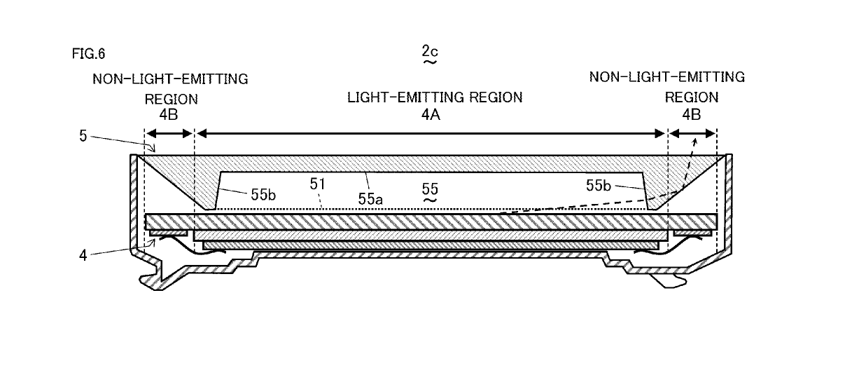

Next, a light source unit which makes up an illumination device according to still another modification example of the above preferred embodiment is described with reference to FIG. 6. In a light source unit 2c which is developed on the basis of the above light source unit 2, a concave part 55 is provided on the light incident surface 51 of the translucent material 5. The concave part 55 faces the light-emitting region 4A of the planar light-emitting panel 4, and has a parallel surface 55a which constitutes a bottom surface of the concave part 55 to be in parallel with the light-emitting region 4A and an orthogonal surface 55b which constitutes a side surface of the concave part 55 to be substantially orthogonal to the light-emitting region 4A. The orthogonal surface 55b is substantially orthogonal to the light-emitting region 4A, so that light (shown by arrows of dash lines) outputted from the planar light-emitting panel 4 toward a side of the light source unit 2c enters the orthogonal surface 55b at a small incident angle. Thus, a total reflection of the light at the orthogonal surface 55b is reduced, so that light extraction efficiency is further enhanced and moreover, the irradiation light luminance in the front direction of the non-light-emitting region 4B increases, thus the irradiation light luminance difference between the non-light-emitting region 4B and the light-emitting region 4A is reduced.

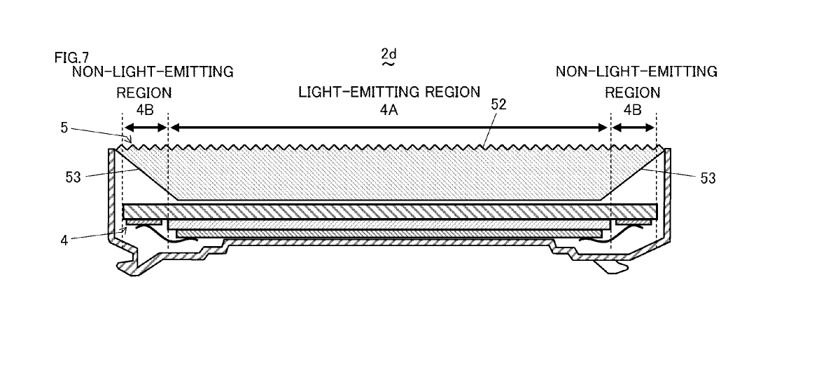

Next, a light source unit which makes up an illumination device according to still another modification example of the above preferred embodiment is described with reference to FIG. 7. In a light source unit 2d which is developed on the basis of the above light source unit 2, a light outputting surface 52 of the translucent material 5 is prepared as a light diffusion surface which diffuses light. Such a light diffusion surface is obtained, for example, by forming fine projections and depressions through a sandblast or frosting processing on the light outputting surface 52. According to such a processing, since the light emitted from the planar light-emitting panel 4 is diffused in various directions in the translucent material 5 and then emitted outside, the luminance unevenness is highly reduced. Moreover, since the light guided in the translucent material 5 is diffused and reflected by the light outputting surface 52, so that the light which reaches the inclined surface 53 increases and a boundary between the light-emitting region 4A and the non-light-emitting region 4B becomes inconspicuous.

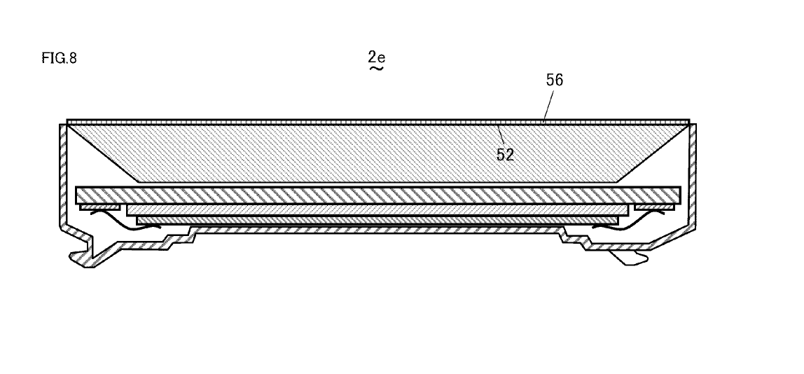

Next, a light source unit which makes up an illumination device according to still another modification example of the above preferred embodiment is described with reference to FIG. 8. In a light source unit 2e which is developed on the basis of the above light source unit 2, a light diffusion layer 56 is further added to the light outputting surface 52 to diffuse the light. The light diffusion layer 56 is formed, for example, by applying diffusion coating or a light diffusion sheet on the light outputting surface 52. According to the light source unit 2e, the effect similar to that of the above light source unit 2d is obtained.

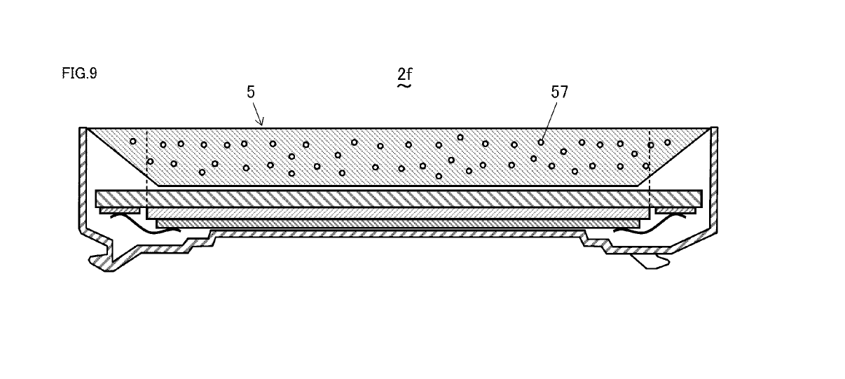

Next, a light source unit which makes up an illumination device according to still another modification example of the above preferred embodiment is described with reference to FIG. 9. In a light source unit 2f which is developed on the basis of the above light source unit 2, a light diffusion agent 57 is included in the translucent material 5 to diffuse the light. Such a light diffusion agent 57 is made up of, for example, particulate titanium dioxide, particulate silicon dioxide or particulate ceramic. When the light diffusion agent 57 is included in the translucent material 5, the light which is diffused by the light diffusion agent 57 and guided in the translucent material 5 increases, so that the luminance unevenness is further reduced and the boundary between the light-emitting region 4A and the non-light-emitting region 4B becomes inconspicuous.

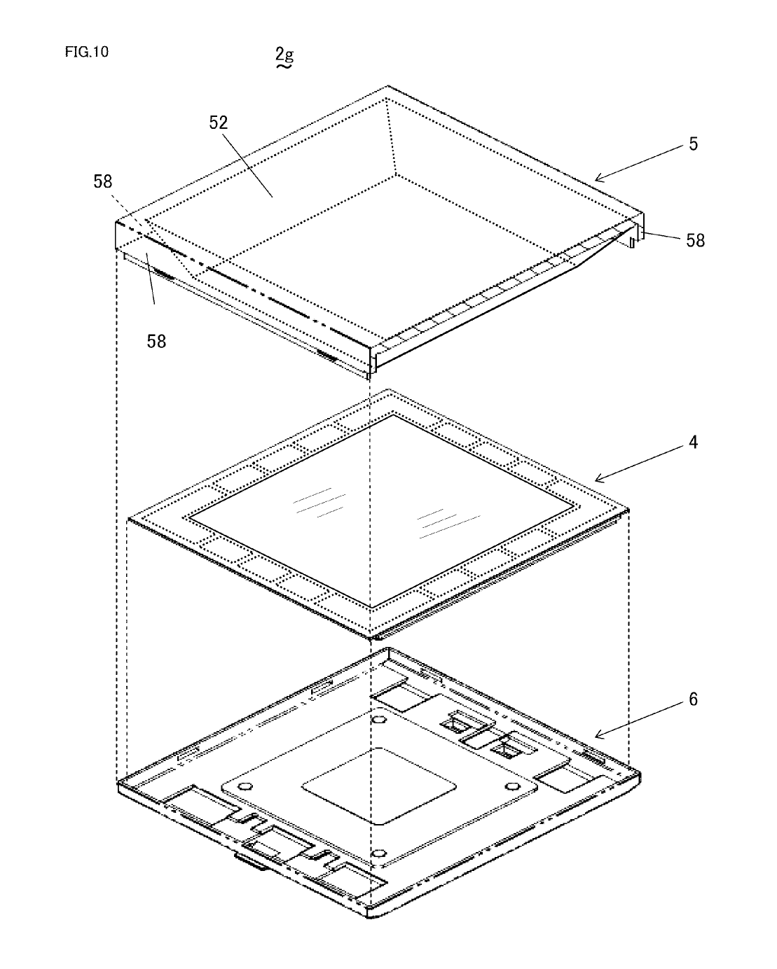

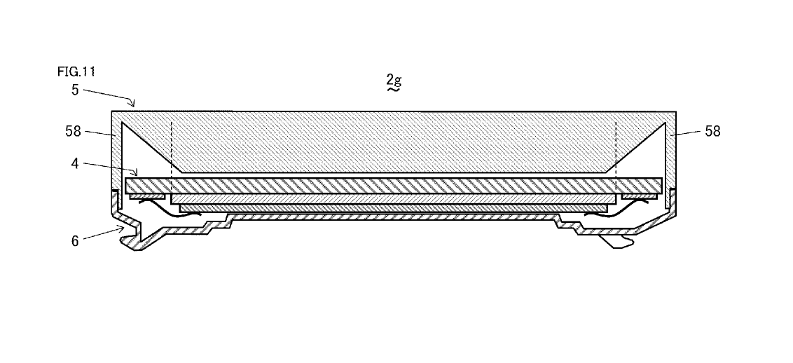

Next, a light source unit which makes up an illumination device according to a second preferred embodiment of the present invention is described with reference to FIGS. 10 and 11. In a light source unit 2g which is developed on the basis of the above light source unit 2, a peripheral frame 58 extends from a periphery of the light outputting surface 52 of the translucent material 5 so as to cover a side surface of the planar light-emitting panel 4. The peripheral frame 58 is made up of a material which is the same with the translucent material 5 and engages with the upper surface side-edge of the backside case 6. According to such a configuration, since the light emitted from the planar light-emitting panel 4 passes through the peripheral frame 58 and is emitted outside, enabling light irradiation to a lateral direction of the light source unit 2g.

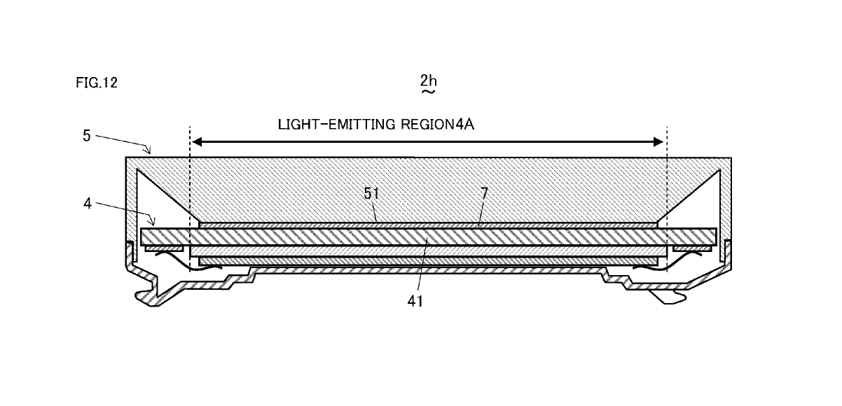

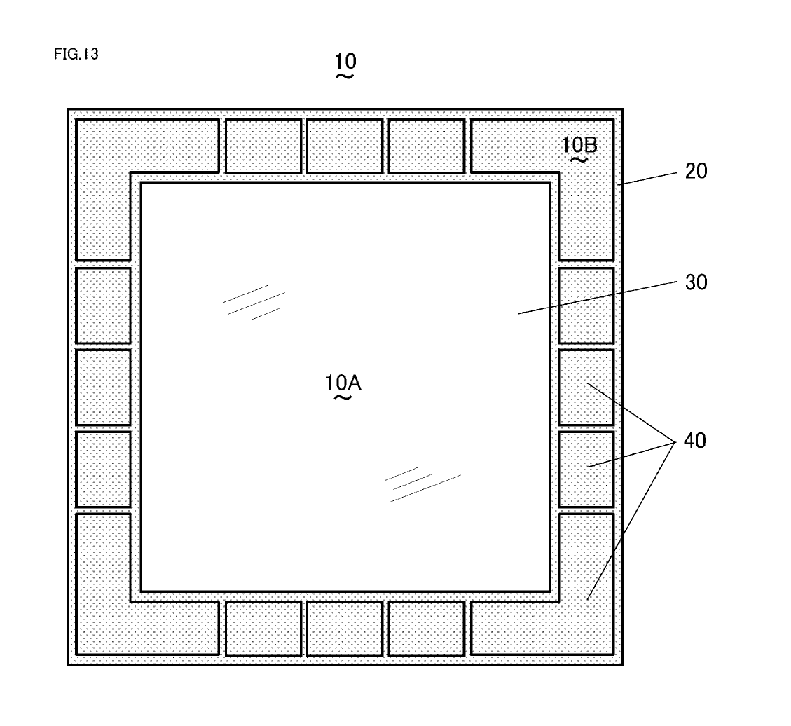

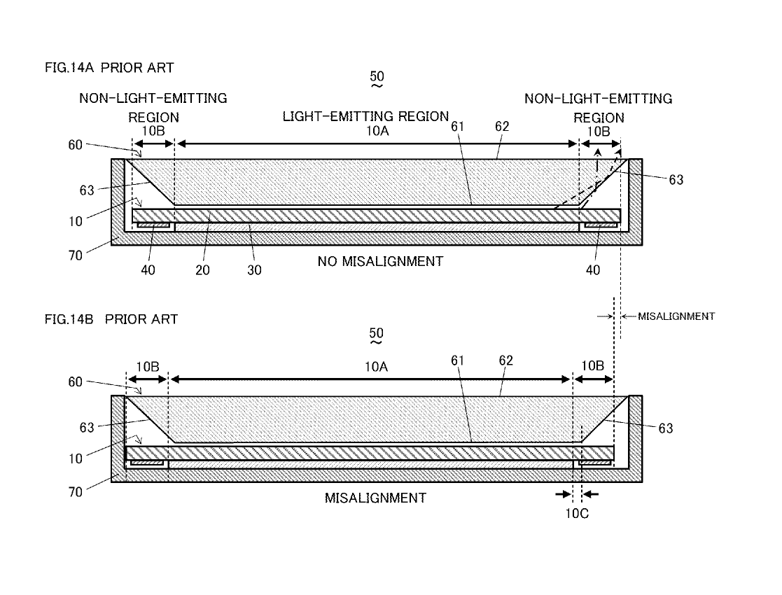

Next, a light source unit which makes up an illumination device according to a modification example of the above preferred embodiment is described with reference to FIG. 12. In a light source unit 2h which is developed on the basis of the above light source unit 2g, the base material 41 (the planar light-emitting panel 4) and the light incident surface 51 of the translucent material 5 are adhered or stuck to each other via a translucent resin 7. The translucent resin 7 is made up of, for example, a material having the same reflective index with the material which constitutes the base material 41 or the translucent material 5, or a material having a reflective index intermediate between the materials which constitute the base material 41 and the translucent material 5. According to such a configuration, a total reflection at a boundary between the base material 41 and the translucent resin 7 as well as a boundary between the translucent resin 7 and the translucent material 5 is reduced, enabling to increase light extraction efficiency.

The illumination device according to the present invention is not limited to the above preferred embodiment and its modification example and various modifications are applicable within the scope of the invention. For example, based on the above light source units 2a, 2c to 2f, the reflection part is provided on the translucent material. Moreover, based on the above light source units 2a, 2d to 2h, the concave part is provided on the translucent material. Moreover, based on the above light source units 2a to 2g, the planar light-emitting panel and the translucent material is adhered or stuck to each other via the translucent resin. Furthermore, based on the above light source units 2a, 2g and 2h, light diffusion ability is added to the translucent material.

### DESCRIPTION OF THE NUMERALS

1 illumination device
4 planar light-emitting panel
4A light-emitting region
4B non-light-emitting region
5 translucent material
51 light incident surface
52 light outputting surface
53 inclined surface
54 reflection part
55 concave part
56 light diffusion layer
57 light diffusion agent
58 peripheral frame
7 translucent resin

1. An illumination device, comprising:
a planar light-emitting panel having a light-emitting surface on one side; and
a flat plate-shaped translucent material disposed on the light-emitting surface side of the planar light-emitting panel, wherein
the planar light-emitting panel has a light-emitting region which emits light and a non-light-emitting region which is located around the light-emitting region and does not emit light,
the translucent material has a light incident surface which faces the light-emitting region for entry of the light outputted from the light-emitting region, a light outputting surface which is located at a side opposite to the light incident surface and from which the light entering from the light incident surface is outputted, an inclined surface which connects a peripheral edge of the light outputting surface and a peripheral edge of the light incident surface and which obliquely extends outward from the peripheral edge of the light incident surface to face the non-light-emitting region, and a concave part provided on the light incident surface, and
the light incident surface is smaller than the light-emitting region in size.

2. The illumination device according to claim 1, wherein
the translucent material has a reflection part on the inclined surface to reflect light.

3. (canceled)

4. The illumination device according to claim 1, wherein
the light outputting surface is prepared as a light diffusion surface which diffuses light.

5. The illumination device according to claim 1, wherein
a light diffusion layer which diffuses light is further added onto the light outputting surface of the translucent material.

6. The illumination device according to claim 1, wherein
the translucent material contains a light diffusion agent which diffuses light.

7. The illumination device according to claim 1, wherein
the light incident surface and the planar light-emitting panel are adhered or stuck to each other via a translucent resin.

8. The illumination device according to claim 1, wherein
the translucent material further has a peripheral frame which extends from a periphery of the light outputting surface so as to cover a side surface of the planar light-emitting panel.
